(19) United States
(12) Patent Application Publication
(10) Pub. No.: US 2005/0227149 A1
(43) Pub. Date: Oct. 13, 2005

(54) Electrode

(75) Inventor: Gamdur Singh Mann, Grand Blanc, MI (US)

Correspondence Address: DELPHI TECHNOLOGIES, INC., M/C 480-410-202, PO BOX 5052, TROY, MI, 48007, US

(73) Assignee: Delphi Technologies, Inc.

(21) Appl. No.: 11/146,837

(22) Filed: Jun. 7, 2005

Related U.S. Application Data
(63) Continuation of application No. 10/091,063, filed on Mar. 4, 2002, now abandoned.

(51) Int. Cl. H01M 4/68; B05D 5/12; H01M 4/73; H01M 4/20; H01M 4/22; H01M 4/57

(52) U.S. Cl. 429/245; 427/126.3; 205/63; 429/228

(57) ABSTRACT

A positive electrode for a lead-acid battery having a heat-treated metal grid with an interconnected grain structure, wherein the grid is heat-treated after being at least partially coated with a paste containing lead. Also disclosed is a method of making a positive electrode for a lead-acid battery including applying a lead containing paste to a metal grid to produce a pasted grid, heating the pasted grid at a temperature and relative humidity sufficient to produce a cured grid, heat treating the cured grid at a temperature of at least about 125° C., for a period of time sufficient to produce an interconnected grain structure within the grid to produce a heat treated grid, and forming the electrode by assembling the heat treated grid into an electrochemical cell including a negative electrode and a sulfuric acid electrolyte, wherein an electric current is passed through the cell to convert at least a portion of the cured paste into lead dioxide.

### BACKGROUND OF THE INVENTION

Electrochemical storage batteries, and in particular, lead sulfuric acid storage batteries are ubiquitous in automotive applications. These batteries have electrochemical cells developing about 2.2 Volts each. Generally, six of these cells are connected in series to produce the 12 Volt battery known as an SLI (starting, lighting, ignition) battery common in automobile systems.

A generic lead acid battery cell has positive plates (electrodes), negative plates (electrodes), and an electrolyte, typically aqueous sulfuric acid (specific gravity about 1.28). The positive plate includes a current collector (grid) which supports chemically active positive material (hereinafter PAM). The negative plate also includes a grid, and negative active material (hereinafter NAM). The plates are held in a substantially parallel orientation and electrically isolated by a porous separator to allow free movement of charged ions.

Lead alloys are used in making both positive and negative grids. Expanded metal and cast grids are commonly used for making pasted plates. The active materials are applied to the grids in the form of a paste. The paste is made by mixing lead oxide, water, sulfuric acid and other minor additives. The compositions of the positive and the negative pastes are different.

Lead acid battery cells are quite unique because the electrolyte actively participates in the energy storage and release process, as represented schematically in Equations 1, 2, 3, and 4 below:

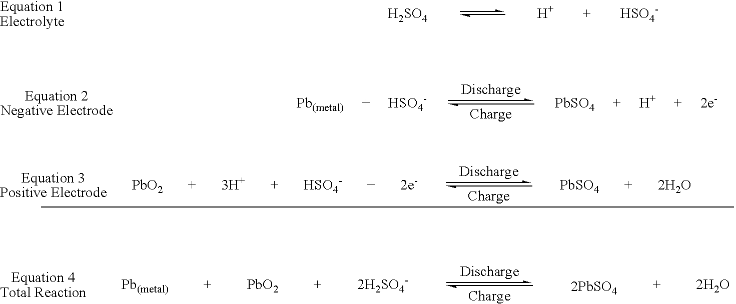

In a fully charged state, PAM exists as PbO₂ at the positive plate. The NAM exists as “sponge lead” at the negative plate. When the cell discharges, both active masses are converted in to PbSO₄ as shown in the above equations. As the cell is charged, via application of an external current, the reverse reactions take place to store electrical energy in the form of chemical energy as indicated above.

It is important to battery performance that the PAM be in physical and electrical contact with the positive grid. Accordingly, the PAM must be supported by, adhered and/or attached to, and in electrical communication with the positive grid for the battery to function properly. Separation of the PAM from the positive grid results in poor battery performance and ultimately in battery failure, which is defined herein as a battery no longer suitable for its intended purpose. This separation is affected by the physiochemical properties of the positive grid/plate such as alloy composition, grid microstructures, physical configuration, and the “curing/setting” forming process of making the plates.

Battery plates are made by a variety of methods. Historically, the processes by which plates are made (i.e., transformed) into positive electrodes have a number of common steps including: pasting, steaming, curing, pickling and/or forming. In pasting, a paste made by mixing water, sulfuric acid, lead and lead oxides is applied to the grid surface. The pasted grid may then be steamed (about 100° C. and 100% humidity) to facilitate crystal growth within the paste. The grid is then “cured” at controlled temperature and humidity conditions to “set” the paste, wherein the paste is chemically transformed into sulfates, hydroxides, carbonates, and other lead compounds through a series of complex hydration reactions requiring the presence of water and oxygen. These reactions take place within the paste itself, and between the paste and the grid metal. Importantly, curing produces a “corrosion layer” at the interface between the grid and the paste, which physically attaches paste to the grid and provides electrical communication between the PAM and the positive grid.

Once cured, the grids are assembled into a battery package and charging electrolyte added. By allowing the battery package to stand for a period of time, the grids are “pickled”. An external electric current is then passed through the cells in the forming step wherein the battery is charged from the first time. A majority of the paste is converted into active materials (×PbO₂) at the positive plate and Pb sponge at the negative plate. The charging electrolyte is then removed and the battery is filled with shipping electrolyte to render the battery ready for use.

The integrity of the corrosion layer is crucial to the operation of the positive plate and hence the performance of the battery for its intended use. The rate of growth of this layer is dependent upon many factors as mentioned above. Once the alloy composition of the positive grid has been selected, the temperature becomes the determining factor for battery life. The interfacial layer grows by diffusion of oxygen ions through the PAM to the grid metal and reacting to produce additional PAM. Higher temperature and charging potential aid this process. The volume of the oxide produced from the lead metal of the grid is larger (about 20-30%) than the metal volume. Consequently, this layer develops mechanical stresses, which result in fracture and spalling of oxide. The end result is separation and/or interruption of electrical contact between PAM and the grid (current collector). Hence, the battery looses its capacity and its useful life decreases.

The rate at which a chemical processes proceed is exponentially proportional to temperature. The corrosion layer growth rate accelerates under high temperature conditions (defined herein as above 50° C.). Automobile underhood temperature has risen significantly due to design trends and space limitations. Therefore, SLI batteries are designed and tested for high temperature (about 75° C.) cycle life (SAE J240 Test).

Accordingly, it is desirable to improve, reduce or substantially eliminate high temperature effects on lead acid battery electrodes. In particular, to provide a longer useful-lifetime of the battery, preferably utilizing materials and processes that provide an economic incentive in doing so.

### SUMMARY OF THE INVENTION

Provided for herein is a positive electrode for a lead-acid battery having a heat-treated metal grid with an interconnected grain structure, wherein the grid is heat-treated after being at least partially coated with a paste containing lead.

Also disclosed is a method of making a positive electrode for a lead-acid battery including applying a lead containing paste to a metal grid to produce a pasted grid, heating the pasted grid at a temperature and relative humidity sufficient to produce a cured grid, heat treating the cured grid at a temperature of at least 125° C., for a period of time sufficient to produce an interconnected grain structure (recrystallized grains) within the grid to produce a heat treated grid, and forming the electrode by assembling the heat treated grid into an electrochemical cell including a negative electrode and a sulfuric acid electrolyte, wherein an electric current is passed through the cell to convert at least a portion of the cured paste into lead oxides, preferably lead dioxide (PbO₂).

### BRIEF DESCRIPTION OF THE DRAWINGS

The improved electrode will now be described, by way of example, with reference to the accompanying drawings, which are meant to be exemplary, not limiting, and wherein like elements are numbered alike in several figures.

FIG. 1 is an expanded view of a lead acid cell;

FIG. 2 is an expanded view of a lead acid battery using the cell of FIG. 1;

FIG. 3 is photomicrograph at 200 times magnification (200×) of a Comparative Example electrode;

FIG. 4 is a photomicrograph at 200× of a Comparative Example electrode after J240 testing at 75° C.;

FIG. 5 is a photomicrograph at 400× of an embodiment after heating and J240 testing at 75° C.;

FIG. 6 is an photomicrograph at 100× of a cross-section of a non-heat treated expanded metal grid;

FIG. 7 is an photomicrograph at 400× of a portion of the expanded metal grid in FIG. 6;

FIG. 8 is an photomicrograph at 100× of a cross-section of an expanded metal grid after curing and heat-treating; and

FIG. 9 is an photomicrograph at 400× of a portion of the expanded metal grid after curing and heat-treating of FIG. 8.

The improved electrode will now be described, by way of example only, with reference to the accompanying drawings, which are meant to be exemplary, not limiting, and wherein like elements are numbered alike in several figures.

### DETAILED DESCRIPTION OF THE INVENTION

It has been discovered that an electrode suitable for use as a positive battery plate or grid, having improved high temperature performance can be obtained through heat treating an expanded metal grid after an applied paste has been cured (i.e., the paste has been set), but prior to pickling and/or forming of the cured electrode.

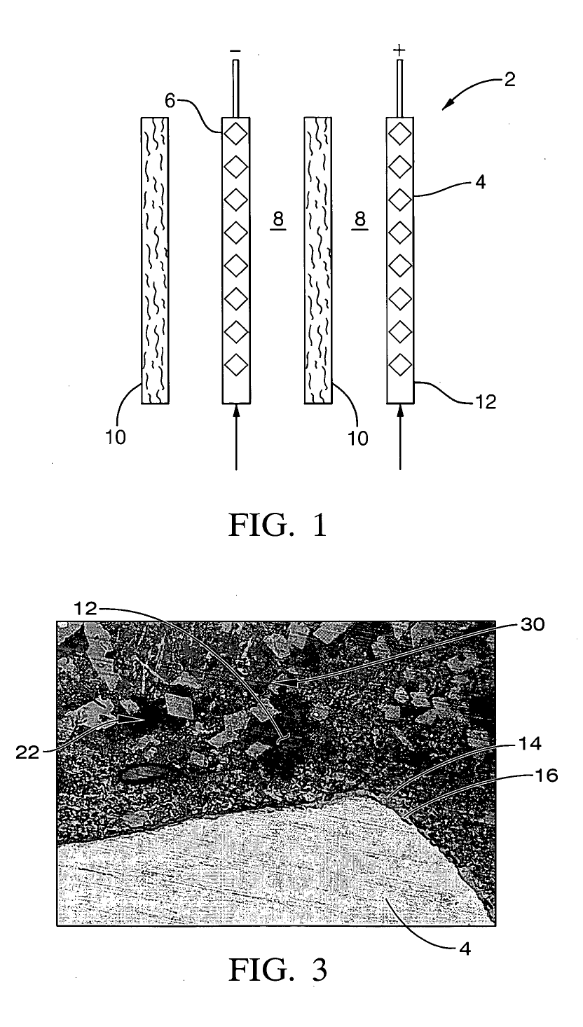

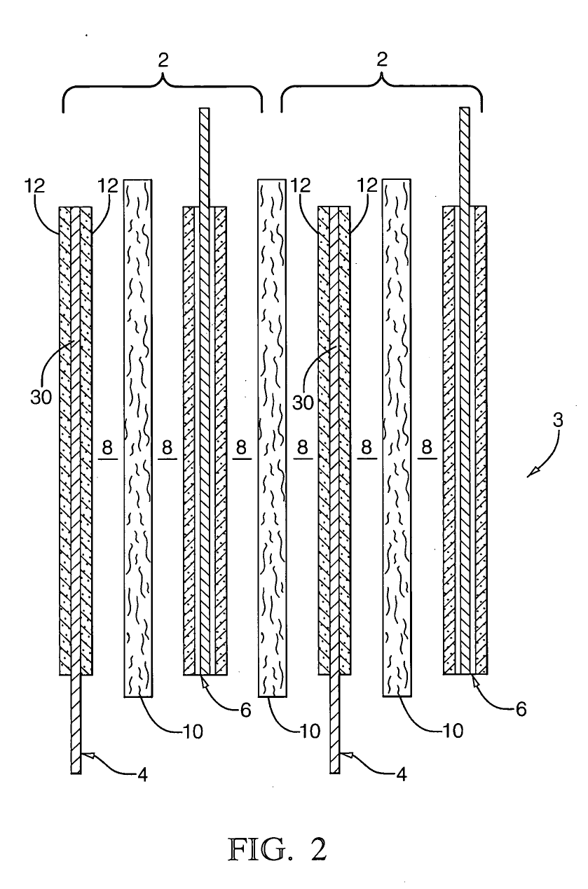

FIG. 1 depicts a two plate generic lead acid cell 2, including a positive electrode 4, a negative electrode 6, and an electrolyte 8, which in this case is aqueous sulfuric acid. The plates are held substantially parallel and electrically isolated by a porous separator 10 to allow free movement of charged ions. The positive active mass 12 is adhered to the surface of the positive grid of electrode 4 (hereinafter grid 4). FIG. 2 depicts a lead acid battery cell 3 having a plurality of cells as shown in FIG. 1.

A suitable electrode grid has high electrical conductivity, mechanical strength sufficient to support the PAM, resistance to corrosion in sulfuric acid, and acceptable processability in formation of the grid. It has been discovered that grid composition and grid formation, both individually and in combination, affect the suitability of a grid. Specifically, while the properties of pure lead render it unacceptable for use as a grid material by itself (because pure lead grids are soft and simply fall apart during use), alloys of lead can be selected to impart the desired properties lacking in pure lead alone.

Alloying metals include antimony (Sb), tin (Sn), silver (Ag), barium (Ba), gold (Au) and calcium (Ca). Antimony alloys have been found to hydrolyze water during charging of the battery. Noble metal alloys (i.e., silver, gold and the like) improve grid conductivity and corrosion resistance, however, noble metals are expensive and result in poor PAM adhesion. Accordingly, the preferred grid material for use herein does not contain antimony and is noble metal free. “Noble metal free” is defined herein as essentially free of noble metals in that while noble metals may naturally occur in trace amounts within the metal alloy, they are not intentionally added to the composition. Sn and Ca are used to impart conductivity, strength and processability into the lead alloy, and do so without the above deleterious side effects. Thus, the preferred alloy for use herein includes lead, tin, and calcium (Pb—Sn—Ca). Preferably, the alloy includes an upper weight percent of lead (Pb Wt %) of about 99.5, with an upper Pb Wt % of about 99 desired, and an upper Pb Wt % of about 98.5 more desired. A lower Pb Wt % of about 50 can be employed, with a lower Pb Wt % of about 90 desired, and a lower Pb Wt % of about 98.3 more desired. Also, the alloy includes an upper weight percent of tin (Sn Wt %) of about 5, with an upper Sn Wt % of about 3 desired, and an upper Sn Wt % of about 2 more desired. A lower Sn Wt % of about 0.5 can be employed, with a lower Sn Wt % of about 1 desired, and a lower Sn Wt % of about 1.4 more desired. In addition, the alloy includes an upper weight percent of calcium (Ca Wt %) of about 1, with an upper Ca Wt % of about 0.5 desired, and an upper Ca Wt % of about 0.1 more desired. A lower Ca Wt % of about 0.01 can be employed, with a lower Ca Wt % of about 0.05 desired, and a lower Ca Wt % of about 0.07 more desired. The most preferred alloy composition includes 98.5 wt % Pb, 1.5 Wt % Sn, and 0.08 Wt % Ca (e.g., 98.5 Pb-1.5Sn-0.08Ca).

Various processes may be used to form the grid including, for example, casting, punching, and expanding metal. In casting, molten lead alloy, often containing Sb to improve castability, is fed into molds to produce a grid without significant mechanical fabrication. Punching uses a die to cut a desired shape out of a lead alloy strip. Both casting and punching result in a relatively dense grid having strength adequate for use in lead acid batteries (i.e., they provide support for the PAM). However, both processes are costly, time consuming, and may require alloys inconsistent with optimal battery performance. By comparison, expanded metal grids are economical, and more suitable for the desired alloy composition. The use of expanded metal techniques includes making partial cuts in a metal strip, and then stretching (i.e., expanding) the strip normal to the cuts to produce the desired grid shape.

A positive plate is made by applying a paste to the expanded grid. The paste is made by mixing lead oxides (micron sized particles with metallic lead at the core and PbO layer on the outside), water, sulfuric acid, and other minor additives. Porous and thin paper is applied to both sides of the pasted plate. This helps in handling of the plates. The paste is applied to the grid (i.e., the grid is pasted) by wiping, extruding, coating and the like. Most preferably the paste is applied in a continuous process. Once pasted, the grids may be flash dried by being briefly (20-30 seconds) subjected to hot air (about 300 to 500° C.) to remove excess surface water. Next, the pasted grid may be “steamed” (i.e., about 100° C. and 100% humidity) for a period of time (i.e., typically around 2 to 4 hours or more) to promote the growth of crystals within the pasted layer prior to curing, wherein the paste is “set” onto the grid surface.

Curing includes holding the pasted plates to a temperature at least about 35° C., more preferably at least about 45° C., with a temperature of at least about 50° C. being more desired. An upper temperature of about 75° C. can be employed, with an upper temperature of about 65° C. desired, and an upper temperature of about 55° C. more desired. Because curing requires water, the process is carried out at a relative humidity of at least about 10, more preferably at least about 15, with a relative humidity of at least about 20% being more desired. An upper relative humidity of about 100% can be employed, with an upper relative humidity of about 70% desired, and an upper relative humidity of about 50% more desired. The time required for the curing process depends on the curing temperature and humidity, as well as the composition of the past. A typical curing time is at least about 20, preferably at least about 30, most preferably at least about 40 hours. The curing step requires a time at most about 200, preferably at most about 150, more preferably at most about 100 hours.

The improvement in the high temperature performance of lead acid batteries described herein results from the cured grids being heat-treated prior to pickling (if done) and/or forming of the electrode. As used herein, heat-treating includes subjecting the cured grid to a temperature, for a period of time sufficient to produce an interconnected grain structure within the metal grid.

In particular, heat-treating includes heating the cured grid (i.e., by placing the cured grids in an oven) at a temperature at least about 1000, with a temperature at least about 125° desired, and a temperature at least about 150° C. more desired. In practice, the upper heat treating temperature is limited by the melting and/or softening point of the metal grid itself, as such, an upper temperature of about 500° is desired, with an upper temperature of about 250° C. more desired.

In combination with temperature is the period of time required to produce the interconnected grain structure within the metal grid. At the above temperatures, a time at least about 1, with a time of at least about 2 desired, and a time of at least about 4 hours is more desired. The time required is also a function of the metal grid composition, as well as other conditions including, for example, the use of different heat transfer mediums, (inert gas, reactive gas, air, oil, sand and the like), discrete temperatures cycles and/or temperature programming including the controlled ramping of the temperature up or down, over at least one discrete temperature range, over at least one discrete time interval, for a determined number of times each, all of which are readily determined by one of skill in the art without undue experimentation.

The effects of heat-treating on the microcrystalline structure of the metal grid are obvious upon visual comparison between cross-sections of heat-treated cured grids and non heat-treated grids of the same type and composition. Specifically, microscopic evaluation of a non heat-treated expanded metal grid show flow lines from the expansion event. In contrast, the same evaluation of the cross-section of the heat-treated cured grid as disclosed herein shows a reduction, if not total elimination, of the flow lines seen prior to heat-treating. In addition, after heat-treating, the interconnected grain structure within the grid is readily discernable. In fact, the grain structure found represents a recystalized interconnect grain structure.

It is important to understand that heat-treating as used herein is different than curing. Curing results in complex chemical processes wherein the paste is transformed (i.e. “set”). Heat-treating, however, affects the microcrystalline structure of the metal grid, but does not substantially affect the physiochemical properties of the cured paste. In fact, experimental results show little change in paste properties when a cured plate was heat-treated at 200° C. for 4 h (e.g., surface area: 0.673 vs. 0.613 m²/g before and after heat-treating).

Also, heat-treating is conducted at temperatures in excess of those required for curing, but necessary for heat-treating. Without being limited by theory, it is believed that by heat-treating the grid after curing (i.e., setting the paste), the “set” paste holds the grid intact to allow the interconnected grain structure to form without adversely affecting the structure of the set paste and corrosion layer. This is in contrast to heat-treating the relatively soft metal grid alone (i.e., the grid prior to curing), which results in a grid un-suitable in physical characteristics for pasting.

After being heat-treated, the grid is then subjected to processing consistent with that described above, including pickling (if needed) followed by forming, wherein an external current converts a majority of the cured paste into PAM to complete the formation of the electrode. The formed electrode can then be evaluated for high temperature performance and durability using the J-240 testing protocol conducted at 75° C., as well as Charge/Discharge analysis of the electrodes themselves.

The J-240 protocol calls for continued charging and discharging of a test battery at a specified temperature, until such time as the battery is no longer able to meet the minimum performance requirements. According to this test, the SLI battery containing the electrodes and the electrolyte is first fully charged. While keeping it at about 75° C. throughout, it is subjected to cyclic discharge-charge cycles. The cycle usually consists of discharge for 4 minutes at 25A followed by a charge period of 10 minutes at 14.8V with a 25A lid. The battery is tested continuously for five days resulting in approximately 500 cycles. The test unit is then allowed to rest at room temperature for 48 hours, and then is tested according to performance criteria, usually CCA (Cold Cracking Amperes). If the battery meets the pass/fail criteria, the test is restarted again. Otherwise, the battery is declared to fail the test, and no further cycling is performed. The above described procedure can also be translated for two/three plate cells for evaluation purposes.

The following examples are presented in order that those skilled in the art may better understand how to practice the present invention. These examples are merely presented by way of illustration only, and are not intended to limit the invention thereto.

### EXAMPLES

### Example 1

### Comparative Examples

Comparative Example 1 represents an historical process of producing the electrode, as described above (i.e., pasting, drying, steaming, curing, pickling, and forming to produce a lead alloy grid having a corrosion layer to which PAM is adhered). Specifically: pure lead was converted into an oxidized lead powder (lead oxide or leady oxide coating a metallic lead center) and was mixed with water and H₂SO₄ under constant stirring at an elevated temperature to form a lead-lead-oxide paste. Analysis of the paste showed a mixture of lead, lead oxide, lead sulfate, and basic lead sulfates such as PbOPbSO₄ (monobasic lead sulfate), 3PbOPbSO₄ (tribasic lead sulfate), and 4PbOPbSO₄ (tetrabasic lead sulfate). The paste was then applied to noble metal free expanded metal grids containing 98.4% lead, 1.5% tin, and 0.08% calcium (98.4 Pb-1.5Sn-0.08Ca). The pasted grids were then steamed for four hours at about 100° C. and 100% humidity. After being steamed, the grids were cured for 3 days at 25% humidity and 50° C.

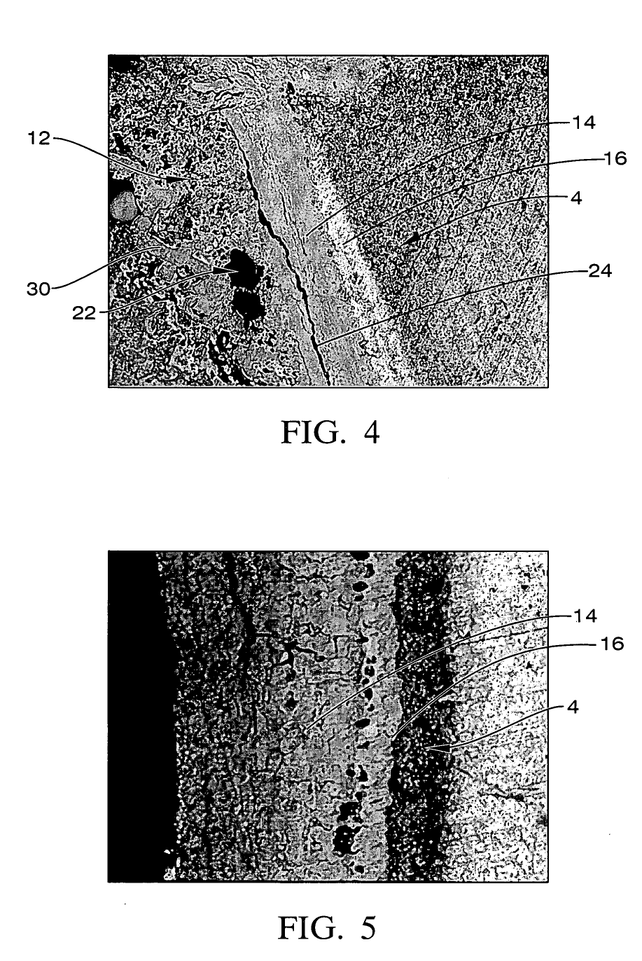

The cured (set) grids were assembled into a battery and forming acid (aqueous sulfuric acid, specific gravity of 1.190) was added. The battery was aged 1 hour to pickle the grids prior to forming, wherein a first forming current of 17 and a second forming current of 12 amps was applied in a two step process. Once full charge had been reached, the forming acid was removed and the battery was filled with shipping acid (aqueous sulfuric acid, specific gravity 1.280). The battery was then subjected to J240 test at 75° C. FIG. 4 shows the effect of this cyclic test on corrosion layer 14.

### Example 2

### Preferred Embodiment

Example 2 represents a preferred embodiment of a heat-treated cured grid as disclosed herein. The grid was the same in all respects to that used in Comparative Example 1 (i.e., an expanded metal 98.4 Pb-1.5Sn-0.08Ca grid), as was the paste described above. The grid was then subjected to the same pasting, steaming, curing, pickling and forming conditions as was Comparative Example 1, except that after curing, and prior to pickling, the cured grid was heat-treated at 150° C. in air for 112 hours before being assembled into a two plate test cell for subsequent processing. Once fully formed, the test cell was subjected to J240 cyclic test at 75° C. as described above. Being a two plate cell, the cycle consisted of discharge at 2.08A for 4 minutes followed by a charge cycle at 2.5V. FIG. 5 shows the effect of these cycles on the morphology of the corrosion layer 14.

Analysis of Data

FIG. 3 depicts a part of the cross section of a comparative example of a positive plate produced by the above-described historical process, wherein a corrosion layer 14 covers grid 4 at interface 16, and adhered to corrosion layer 14 is a layer of PAM 12. Also present in FIG. 3 are tetrabasic lead sulfate crystals and some porosity. FIG. 4 shows the same interface area shown in FIG. 3 after high temperature cyclic testing. The corrosion layer 14 is thicker, and has separation crack 24. This results in electrical disconnect between the PAM 12 and the grid 4. Accordingly, the detrimental effects of grid corrosion and thermal expansion illustrated in FIG. 4 result in PAM separation and eventually in battery failure. FIG. 5 shows a positive plate as described herein which was heat treat after curing. The corrosion layer 14 is again grown in thickness due to high temperature cyclic testing, but does not show type of cracking and separation similar to that of Comparative Example shown in FIG. 4. Consequently, the electrical contact between the PAM 12 and grid 4 is maintained through the interface layer 14.

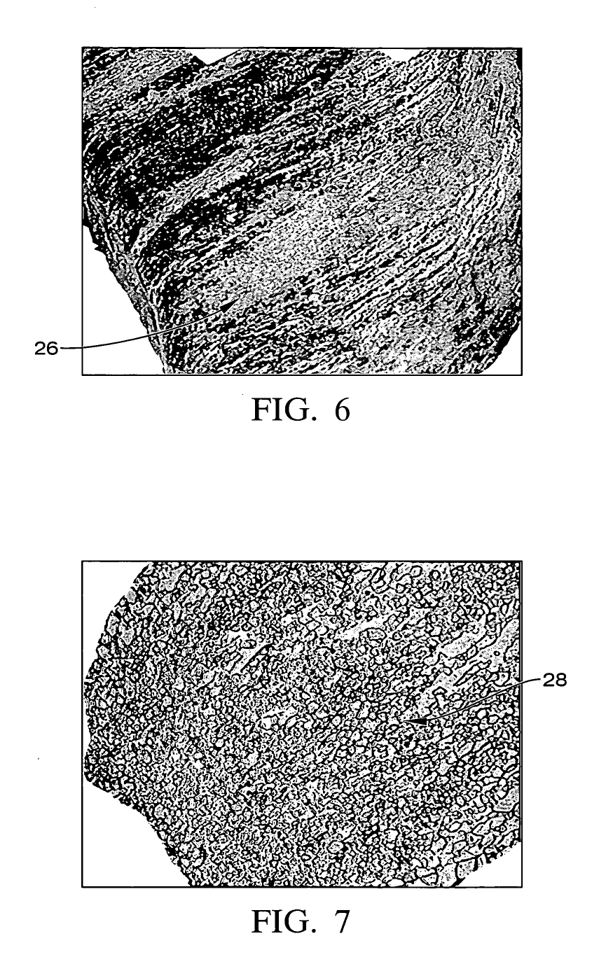

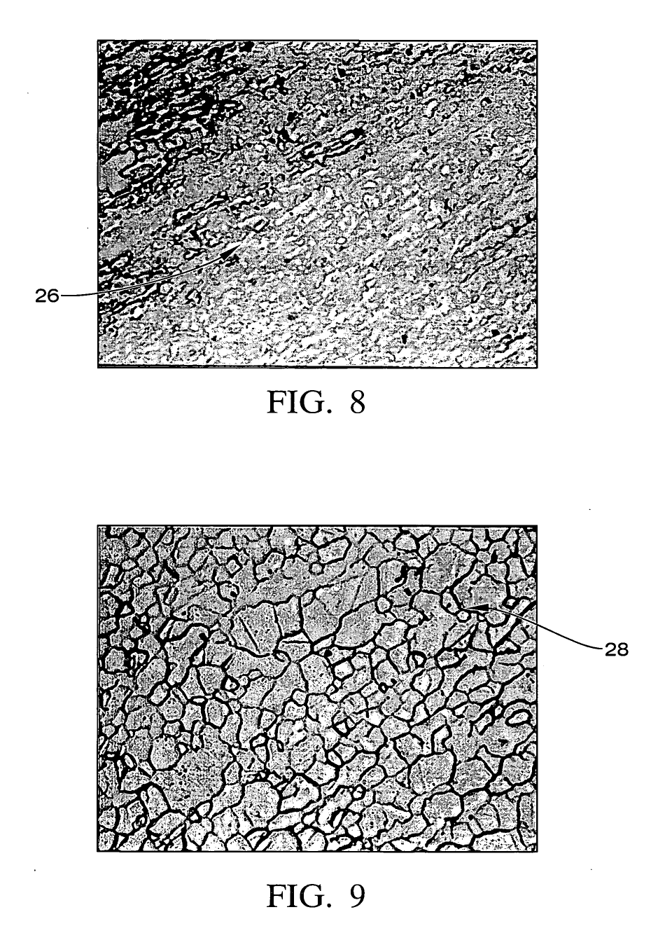

FIG. 6 shows a cross section at 100 times magnification (100×) of a the non heat-treated expanded metal grid of COMPARATIVE EXAMPLE 1. Flow lines 26 from the expansion of the grid are clearly present. In contrast, FIG. 7 shows a cross-section of the heat-treated cured grid of preferred embodiment EXAMPLE 2 at the same level of magnification. The flow lines seen in COMPARATIVE EXAMPLE 1 (see 26, FIG. 6) are not present after heat-treating, while the interconnected grain structure 28 that results from the heat-treating is readily discernable in EXAMPLE 2. FIGS. 8 and 9 show the two grids of FIGS. 6 and 7 respectively at 400×, wherein the interconnected grain structure that results from heat-treating of the cured grid (28 of EXAMPLE 2) shown in FIG. 9 is further pronounced, as compared to the non heat-treated grid of COMPARATIVE EXAMPLE 1 shown in FIG. 8.

While preferred embodiments have been shown and described, various modifications and substitutions may be made thereto without departing from the spirit and scope of the invention. Accordingly, it is to be understood that the apparatus and method have been described by way of illustration only, and such illustrations and embodiments as have been disclosed herein are not to be construed as limiting to the claims.

1. A positive electrode for a lead-acid battery comprising a heat-treated metal grid having an interconnected grain structure, wherein said grid is heat-treated after being at least partially coated with a paste comprising lead.

2. The positive electrode of claim 1, wherein said heat-treated metal grid comprises lead and optionally further comprises tin, calcium, or a combination comprising at least one of the foregoing.

3. canceled

4. The positive electrode of claim 3, wherein said heat-treated metal grid comprises at least about 98.5% by weight lead, at least about 1.5% by weight tin, and at least about 0.08% by weight calcium.

5. The positive electrode of claim 1, wherein said heat-treated metal grid prior to heat-treating, is comprised of expanded metal.

6. The positive electrode of claim 1, wherein said paste further comprises lead oxides, water, sulfuric acid, or combinations comprising at least one of the foregoing.

7. The positive electrode of claim 1, wherein said paste coated grid is heating at about 35° C. to about 75° C., and at about 10% to about 90% humidity, for a time sufficient to cure said paste onto the surface of said grid prior to heat treating said grid.

8. The positive electrode of claim 1, wherein said grid is heat-treated at a temperature of at least about 150° C., for a period of time sufficient to produce said interconnected grain structure within said heat-treated grid.

9. The positive electrode of claim 8, wherein said heat-treated grid is assembled into an electrochemical cell having a negative electrode and a sulfuric acid containing electrolyte, wherein an electric current is passed through said cell such that at least a portion of said paste is converted into lead dioxide.

10. The positive electrode of claim 1, wherein said heat-treated metal grid, assembled into a cell according to test J-240, has an expiration time of at least 2000 cycles wherein said test J-240 is conducted at 75° C.

11. The positive electrode of claim 1, wherein said interconnected grain structure is a recystallized interconnected grain structure.

12. A method of making a positive electrode for a lead-acid battery comprising:
applying a lead containing paste to a metal grid to produce a pasted grid;
heating said pasted grid at a temperature and relative humidity sufficient to produce a cured grid;
heat treating said cured grid at a temperature of at least about 125° C., for a period of time sufficient to produce an interconnected grain structure within said grid to produce a heat treated grid; and
forming said electrode by assembling said heat treated grid into an electrochemical cell comprising a negative electrode and a sulfuric acid electrolyte, wherein an electric current is passed through said cell to convert at least a portion of said cured paste into a coating of lead oxides.

13. The method of claim 12, wherein said metal grid comprises lead.

14. The method of claim 13, wherein said metal grid further comprises tin, calcium, or a combination comprising at least one of the foregoing.

15. The method of claim 14, wherein said metal grid comprises about 98.5% by weight lead, about 1.5% by weight tin, and about 0.08% by weight calcium.

16. The method of claim 12, wherein said metal grid is comprised of expanded metal.

17. The method of claim 12, wherein said paste further comprises lead oxides, water, sulfuric acid, or combinations comprising at least one of the foregoing.

18. The method of claim 12, wherein said pasted grid is heated to a temperature between about 35° C. and about 75° C., at between about 10% and about 90% humidity, for a time sufficient to produce said cured grid.

19. The method of claim 12, wherein said cured grid is heat-treated at a temperature at least about 150° C., for a period of time sufficient to produce said interconnected grain structure within said heat-treated grid.

20. The method of claim 12, wherein said heat-treated metal grid, assembled into a cell according to test J-240, has an expiration time of at least about 2000 cycles when said test J-240 is conducted at 75° C.

21. The method of claim 12, wherein said interconnected grain structure is a recystalized interconnected grain structure.
